(19) United States
(12) Patent Application Publication
(10) Pub. No.: US 2005/0012905 A1
(43) Pub. Date: Jan. 20, 2005

(54) Projector

(76) Inventor: Kenichi Morinaga, Osaka (JP)

Correspondence Address: Jonathan P. Osha;Osha & May L.L.P., Suite 2800, 1221 McKinney St., Houston, TX, 77010, US

(21) Appl. No.: 10/890,715

(22) Filed: Jul. 14, 2004

(30) Foreign Application Priority Data
Jul. 17, 2003 (JP) P. 2003-198172

(51) Int. Cl. G03B 21/18

(52) U.S. Cl. 353/58

(57) ABSTRACT

A projector includes a light source lamp, a projection lens, a DMD device, a temperature controlling fan, an optical part, a cooling fan, and a heat radiating plate. Preferably, the heat radiation plate is provided in a path to the fans and in close proximity to the DMD device, and includes a base portion and a plurality of heat radiating fin portions, which are provided integrally on a surface of the base portion, are spaced apart at predetermined intervals and extend in a perpendicular direction to the surface of the base portion. Each of the plurality of heat radiating fin portions has a plurality of through holes which extend in a direction along the path to the fans and are spaced apart at predetermined intervals. An outer surface of the heat radiating fin portion has a shape which reflects a shape of the plurality of through holes.

### BACKGROUND OF THE INVENTION

1. Field of the Invention

The present invention relates to a projector, and more particularly to a projector including heat radiating fin portions for radiating heat generated during operation.

2. Description of the Related Art

Conventionally, a projector including heat radiating fin portions for radiating heat generated during operation is known (e.g., refer to JP-A-2002-90886 and JP-A-2002-174795).

The aforementioned JP-A-2002-90886 discloses a projector in which a heat radiating fin portion is formed on an outer surface of a color wheel case or accommodating a color wheel, whereby the heat generated from the color wheel rotating at high speed during the operation of the projector is radiated from the heat radiating fin portion.

In addition, the aforementioned JP-A-2002-174795 discloses a projector in which a heat radiating plate having a heat radiating fin portion is provided in an abutting manner on a DMD device (DMD™: Digital Micromirror Device) for supplying light to a projection lens by reflecting the light, so as to radiate the heat of the DMD device from the heat radiating fin portion of the heat radiating plate during the operation of the projector.

FIG. 5 is perspective view illustrating an overall configuration of a projector having a heat radiating plate including heat radiating fin portions for radiating the heat of a DMD device in accordance with a conventional example. FIG. 6 is a top view of the projector in accordance with the conventional example shown in FIG. 5. FIG. 7 is a perspective view of the heat radiating plate used in the projector in accordance with the conventional example shown in FIG. 5. First, referring to FIGS. 5 to 7, a description will be given of the structure of the projector having the heat radiating plate including the heat radiating fin portions for radiating the heat of the DMD device in accordance with the conventional example.

As shown in FIG. 5, a projector apparatus having a heat radiating plate including heat radiating fin portions in accordance with a conventional example has a lower case 101, a front case 102, and a rear case 103. A ventilation port 101a for introducing air is provided in a side surface of the lower case 101. The front case 102 is attached to the lower case 101, and the rear case 103 is attached to the lower case 101. Further, a ventilation port 103a for introducing air is provided in the rear case 103.

In addition, a lamp case holder 104 is installed in the lower case 101 in the vicinity of the front case 102. As shown in FIG. 6, a lamp case 106 with a light source lamp 105 fitted therein is accommodated inside this lamp case holder 104. The light source lamp 105 has a light source 105a for emitting light and a reflector 5b for reflecting and focusing the light emitted from the light source 105a. In addition, as shown in FIGS. 5 and 6, a temperature controlling fan 107 for controlling the temperature of the light source lamp 105 by sending air to the light source lamp 105 is provided laterally of the lamp case 106 with the light source lamp 105 fitted therein and the lamp case holder 104.

In addition, a casting 108 having a lens fitting portion 108a is installed in the lower case 101. A projection lens 109 for projecting an image is fitted in the lens fitting portion 108a of the casting 108. In addition, as shown in FIG. 6, a light tunnel 110 for shaping the light into a rectangular form is attached to the casting 108 at a position where the light radiated from the light source 105a of the light source lamp 105 is focused. This light tunnel 110 is fixed to the casting 108 by means of a light tunnel clip 111. In addition, the light tunnel 110 has an entrance portion 110a into which the light from the light source lamp 105 is incident and an exit portion 110b from which the incident light is emergent, and the light tunnel 110 is formed in a tubular tetrahedral shape. Further, a transmitting member 112, through which the light shaped by the light tunnel 110 is transmitted, is attached to the casting 108 on the exit portion 110b side of the light tunnel 110. In addition, a cooling fan 113 is installed laterally of the light tunnel 110 and the transmitting member 112 in such a manner as to be adjacent to the temperature controlling fan 107. This cooling fan 113 is provided to cool optical parts such as the light tunnel 110 and the transmitting member 112 by sending air to the optical parts such as the light tunnel 110 and the transmitting member 112.

In addition, a mirror 114 for reflecting the light transmitted through the transmitting member 112 is installed on the casting 108. Further, a DMD device 115 for further reflecting the light reflected by the mirror 114 and supplying the light to the projection lens 109 is provided at a position opposing the lens fitting portion 108a of the casting 108. A lens 116 for focusing the light reflected by the mirror 114 onto the DMD device 115 is provided between the DMD device 115 and the mirror 114. In addition, the DMD device 115 is mounted on a printed board 119. A through hole (not shown) is provided in the printed board 119 at that position on the printed board 119 that corresponds to the DMD device 115.

In addition, a heat radiating plate 120 for radiating the heat of the DMD device 115 is provided so as to abut against the DMD device 115 through the through hole (not shown) in the printed board 119. As shown in FIG. 6, this heat radiating plate 120 is installed in a path of influx (arrow A in FIG. 6) of air from the ventilation port 101a of the lower case 101 to the temperature controlling fan 107 and the cooling fan 113. In addition, the heat radiating plate 120 has a base portion 120a and radiating fin portions 120c, as shown in FIG. 7. Four threaded holes 120d are provided in the base portion 120a of the heat radiating plate 120. A screw 122 loaded with a compression coil spring 121 is inserted in each of the four threaded holes 120d. The heat radiating plate 120 is attached to the casting 108 through the printed board 119 by means of these screws 122. It should be noted that the compression coil spring 121 loaded on the screw 122 is provided to abut the heat radiating plate 120 against the DMD device 115 with a fixed pressing force.

In addition, as shown in FIG. 7, four heat radiating fin portions 120c formed in the shape of flat surfaces are provided on the surface of the base portion 120a of the heat radiating plate 120 by being spaced apart at predetermined intervals. In addition, the heat radiating fin portions 120c are formed in such a manner as to extend in a substantially perpendicular direction to the surface of the base portion 120a.

Next, referring to FIG. 6, a description will be given of the operation of the projector having the heat radiating plate including the heat radiating fin portions for radiating the heat of the DMD device in accordance with the conventional example. First, as shown in FIG. 6, the light emitted from the light source 105a of the light source lamp 105 is focused by the reflector 105b of the light source lamp 105, and is thereby made incident into the entrance portion 110a of the light tunnel 110. Then, the light incident into the entrance potion 110a of the light tunnel 110 is shaped into a rectangular form and is made emergent from the exit potion 10b of the light tunnel 110. The light emergent from the exit potion 10b of the light tunnel 110 advances in the direction of arrow B in FIG. 6, is transmitted through the transmitting member 12, and is made incident upon the mirror 114. The light incident upon the mirror 114 is reflected by the mirror 114 in the direction of arrow C in FIG. 6. The light reflected by this mirror 114 is made incident upon the DMD device 115 through the lens 116. The light incident upon the DMD device 115 is reflected by the DMD device 115 in the direction of arrow D in FIG. 6, and is supplied to the projection lens 109. Consequently, the image is projected from the projection lens 109 onto a screen or the like.

During the operation of the above-described projector, the temperature controlling fan 107 and the cooling fan 113 are rotated. First, as the temperature controlling fan 107 is rotated, a predetermined volume of air is sent to the light source lamp 105. As a result, the temperature of the light source lamp 105 is controlled to a predetermined temperature. Further, as the cooling fan 113 is rotated, a predetermined volume of air is sent to the optical parts such as the light tunnel 110 and the transmitting member 12. Consequently, the optical parts such as the light tunnel 110 and the transmitting member 12 are cooled. In addition, as the temperature controlling fan 107 and the cooling fan 113 rotate, air flows to the temperature controlling fan 107 and the cooling fan 113 from the ventilation port 101a of the lower case 101 and the ventilation port 103a of the rear case 103, as shown in FIG. 6. The air which flowed in from the ventilation port 101a of the lower case 101 passes the vicinity of the heat radiating plate 120 for radiating the heat of the DMD device 115, and flows in to the temperature controlling fan 107 and the cooling fan 113.

### SUMMARY OF THE INVENTION

With the heat radiating plate 120 of the projector in accordance with the conventional example shown in FIGS. 6 and 7, since the surface of the heat radiating fin portion 120c has a flat shape, it has been difficult to sufficiently increase the surface area of the heat radiating fin portion 120c. For this reason, there has been a drawback in that it is difficult to obtain a sufficient heat dissipation effect. Accordingly, in order to obtain a sufficient heat dissipation effect, it is conceivable to increase the number of the heat radiating fin portions 120c or make the heat radiating fin portions 120c large.

However, if the number of the heat radiating fin portions 120c is increased or their size is made large, as described above, the air which flowed in from the ventilation port 101a of the lower case 101 is interrupted from passing to the side of the temperature controlling fan 107 and the cooling fan 113. Hence, the effect of cooling the heat radiating fin portions 120c by the passage of air becomes small. For this reason, even if the number or sizes of the heat radiating fin portions 120c are increased to some extent, it is, after all, difficult to obtain a sufficient heat dissipation effect. As a result, there has been a problem in that it is difficult to effectively control the rise in the temperature of the DMD device 115.

In addition, also in the projectors disclosed in JP-A-2002-90886 and JP-A-2002-174795 mentioned above, since the surface of the heat radiating fin portion has a flat shape, and the number of heat radiating fin portions is large, in the case where the heat radiating fin portions are installed in the path of influx of air to the fans, it is difficult to obtain a sufficient heat dissipation effect in the same way as the projector in accordance with the conventional example shown in FIG. 5. For this reason, there has been a problem in that it is difficult to effectively control the rise in the temperature of the DMD device.

The present invention has been devised to overcome the above-described problems, and an object of the invention is to provide a projector which, in the case where the heat radiating fin portions are installed in the path of influx of air to the fan, is capable of effectively controlling the rise in the temperature of the device supplied for the projection lens by reflecting the light emitted from the light source lamp, without substantially increasing the number and size of the heat radiating fin portions.

To attain the above object, a projector in accordance with a first aspect of the invention includes a light source lamp, a projection lens which projects an image, a DMD device which reflects light emitted from the light source lamp and supplies the light to the projection lens, a temperature controlling fan which controls a temperature of the light source lamp by sending air to the light source lamp, an optical part, a cooling fan which cools the optical part by sending air to the optical part, and a heat radiating plate which radiates a heat of the DVD device. Preferably, the heat radiation plate is provided in a path of influx of air to the temperature controlling fan and the cooling fan and in close proximity to the DMD device, and includes a base portion and a plurality of heat radiating fin portions, the base portion having a portion located in close proximity to the DMD device, and the plurality of heat radiating fin portions being provided integrally on a surface of the base portion, being spaced apart at predetermined intervals and extending in a substantially perpendicular direction to the surface of the base portion, each of the plurality of heat radiating fin portions has a plurality of through holes through which air can pass and which extend in a direction along the path of influx of air to the temperature controlling fan and the cooling fan, the plurality of through holes being spaced apart at predetermined intervals along the substantially perpendicular direction to the surface of the base portion, and an outer surface of the heat radiating fin portion is formed in a shape in which a plurality of convex portions having a convex shape reflecting a shape of the plurality of through holes are connected.

In the projector according to this first aspect, as described above, the heat radiating fin portions are provided on the heat radiating plate for radiating the heat of the DMD device, and the plurality of through holes are provided in each of these heat radiating fin portions by being spaced apart at predetermined intervals along a substantially perpendicular direction to the surface of the base portion of the heat radiating plate. Therefore, it is possible to increase the surface areas of the heat radiating fin portions by the portion of the surface areas of the through holes. Consequently, it is possible to improve the heat dissipation effect of the heat radiating plate without substantially increasing the number and size of the heat radiating fin portions, so that it is possible to effectively control the rise in the temperature of the DMD device. In addition, by providing the heat radiating fin portions with the through holes, the air is allowed to pass through the through holes of the heat radiating fin portions. Therefore, by virtue of the radiation of heat from the surfaces of the through holes, the air whose temperature has risen can be checked from stagnating in the through holes. Consequently, it is possible to further improve the heat dissipation effect of the heat radiating plate. In addition, as the through holes of the heat radiating fin portions are provided in such a manner as to extend in the direction along the path of influx of air to the temperature controlling fan and the cooling fan, the air directed toward the temperature controlling fan and the cooling fan passes through the through holes. Therefore, even if the heat radiating plate including the heat radiating fin portions is provided in the path of influx of air to the temperature controlling fan and the cooling fan, it is possible to check the interruption of the flow of air directed toward the temperature controlling fan and the cooling fan by the heat radiating plate. Consequently, since it is possible to check the interruption of the influx of air to the temperature controlling fan and the cooling fan, a predetermined volume of air can be sent to the light source lamp and the optical parts by the temperature controlling fan and the cooling fan, respectively. For this reason, it is possible to more reliably maintain the temperature of the light source lamp at a predetermined temperature, and more effectively cool the optical parts by the cooling fan. Thus, since the temperature of the light source lamp can be more reliably maintained at the predetermined temperature, it is possible to prevent the breakage of the light source lamp caused by the fact that the temperature of the light source lamp rises above a predetermined temperature, and suppress a decline in the luminance of the light source lamp owing to the fact that the temperature of the light source lamp falls below a predetermined temperature. In addition, as the outer surfaces of the heat radiating fin portion are formed in a shape in which a plurality of convex portions having convex shapes reflecting the shapes of the through holes are connected, the surface area of the heat radiating fin portion can be increased further as compared with the case where the outer surfaces of the heat radiating fin portion of the heat radiating plate are formed in the shape of flat surfaces. As a result, since the heat dissipation effect can be improved further, it is possible to more effectively control the rise in the temperature of the DMD device as compared with the case where the outer surfaces of the heat radiating fin portion of the heat radiating plate are formed in the shape of flat surfaces. In addition, as the heat radiating fin portions including the through holes are integrally formed on the base portion of the heat radiating plate, the number of parts does not increase even if the heat radiating fin portions including the through holes are provided.

A projector in accordance with a second aspect of the invention includes a light source lamp, a projection lens, a device which reflects light emitted from the light source lamp and supplies the light to the projection lens, and a heat radiating plate which radiates a heat of the device. Preferably, the heat radiating plate includes a heat radiating fin portion which has a through hole through which air can pass.

In the projector according to this second aspect, as described above, the heat radiating fin portion is provided on the heat radiating plate for radiating the heat of the DMD device, and the through hole is provided in the heat radiating fin portion. Therefore, it is possible to increase the surface area of the heat radiating fin portion by the portion of the surface area of the through hole. Consequently, it is possible to improve the heat dissipation effect of the heat radiating plate. For this reason, it is possible to effectively control the rise in the temperature of the DMD device without substantially increasing the number and size of the heat radiating fin portions. In addition, by providing the heat radiating fin portion with the through hole through which air can pass, the air is allowed to pass through the through hole of the heat radiating fin portion. Therefore, by virtue of the radiation of heat from the surface of the through hole, the air whose temperature has risen can be checked from stagnating in the through hole. Consequently, it is possible to further improve the heat dissipation effect of the heat radiating plate.

### BRIEF DESCRIPTION OF THE DRAWINGS

Preferred embodiment of the present invention will be described in detail based on the following figures, wherein:

FIG. 1 is a perspective view illustrating an overall configuration of a projector in accordance with an embodiment of the invention;

FIG. 2 is a top view of the projector in accordance with the embodiment shown in FIG. 1;

FIG. 3 is a cross-sectional view for explaining a structure for attaching a DMD device and a heat radiating plate used in the projector in accordance with the embodiment shown in FIG. 1;

FIG. 4 is a perspective view of the heat radiating plate used in the projector in accordance with the embodiment shown in FIG. 1;

FIG. 5 is perspective view illustrating an overall configuration of a projector having a heat radiating plate including heat radiating fin portions for radiating the heat of a DMD device in accordance with a conventional example;

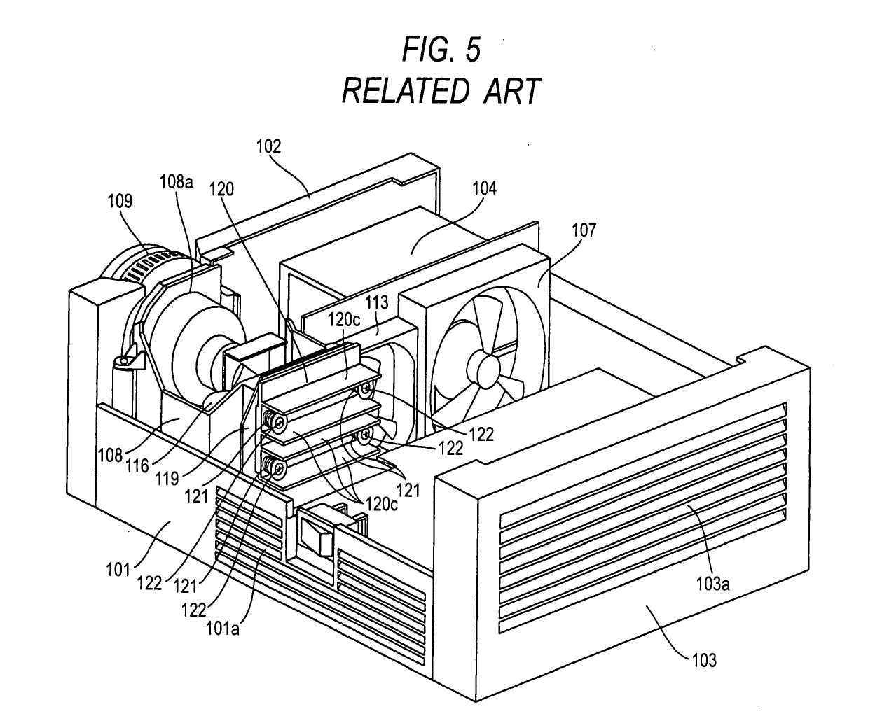

FIG. 6 is a top view of the projector in accordance with the conventional example shown in FIG. 5; and

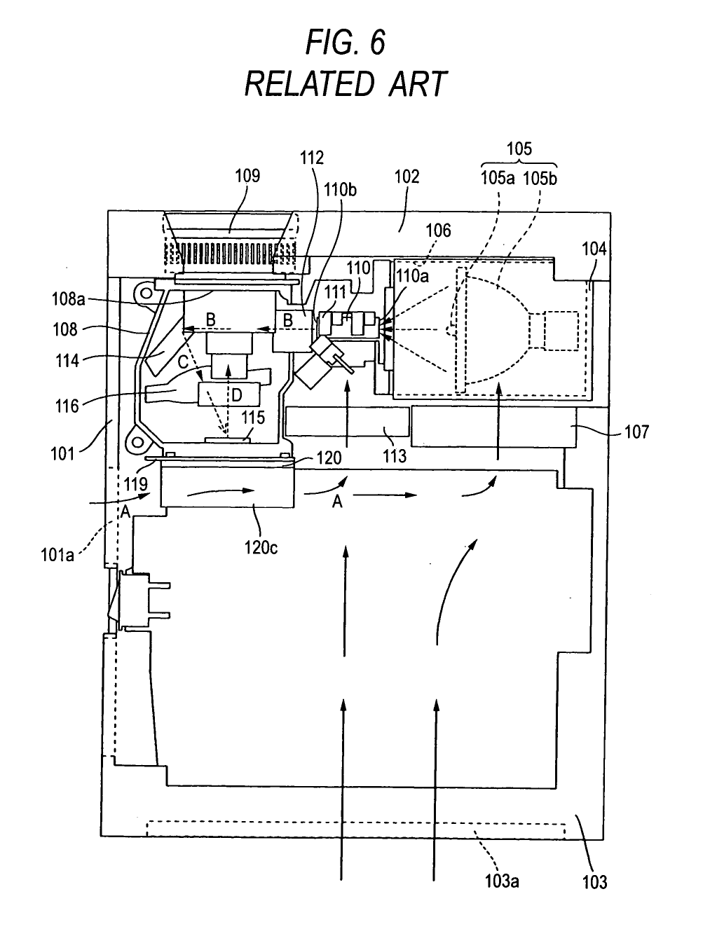

FIG. 7 is a perspective view of the heat radiating plate used in the projector in accordance with the conventional example shown in FIG. 5.

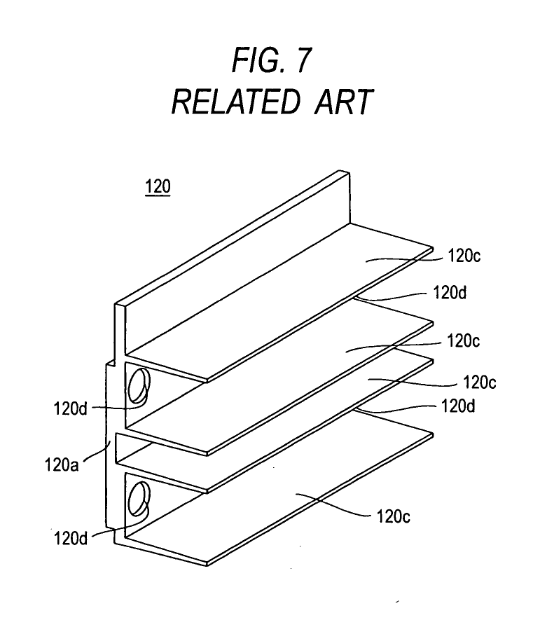

### DETAILED DESCRIPTION OF THE INVENTION

Hereafter, a description will be given of an embodiment of the invention with reference to the drawings.

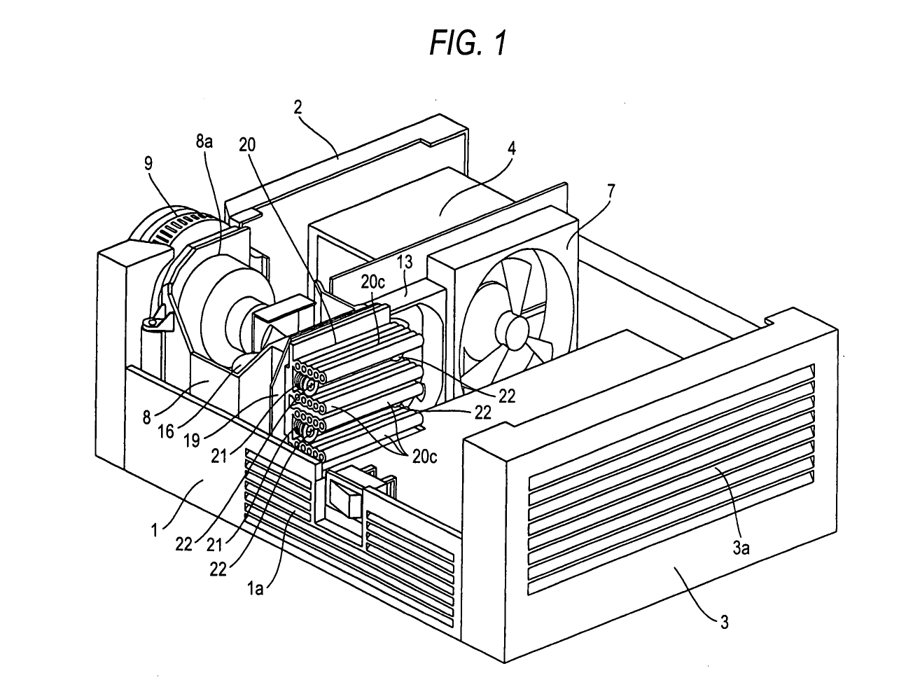

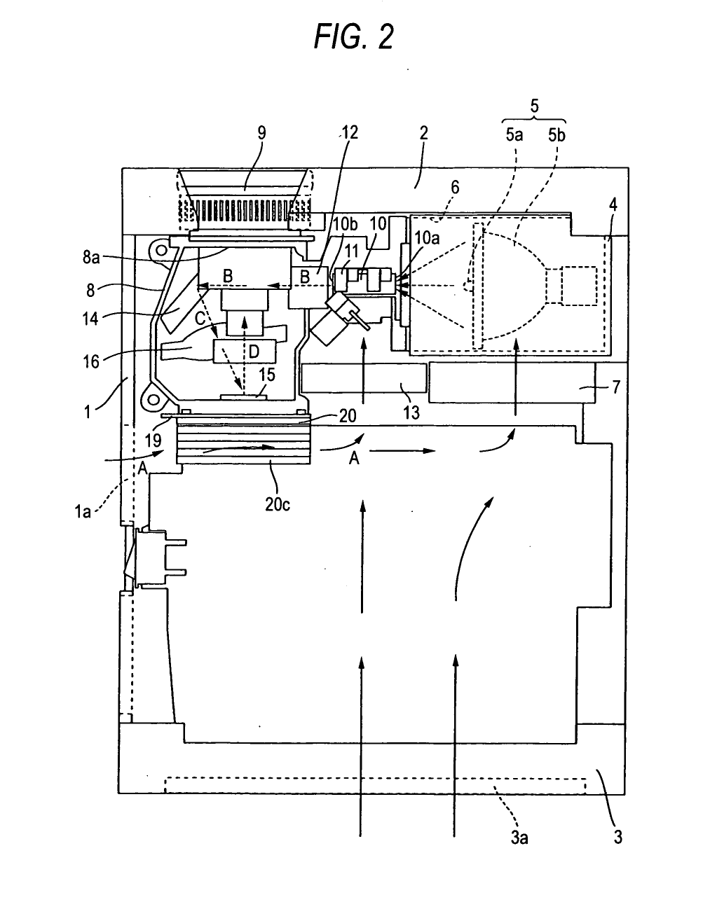

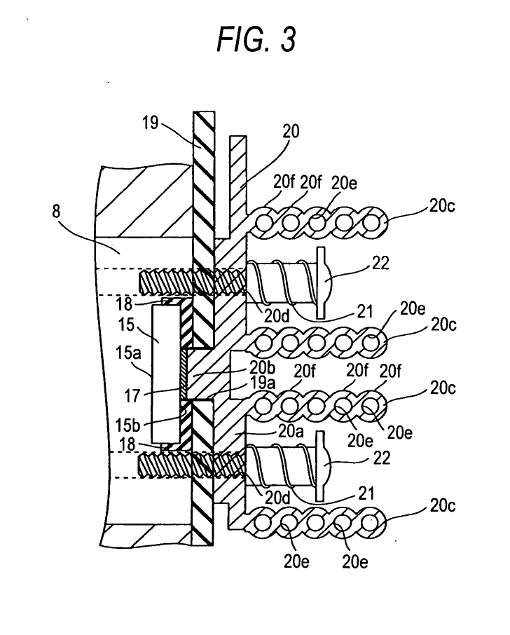

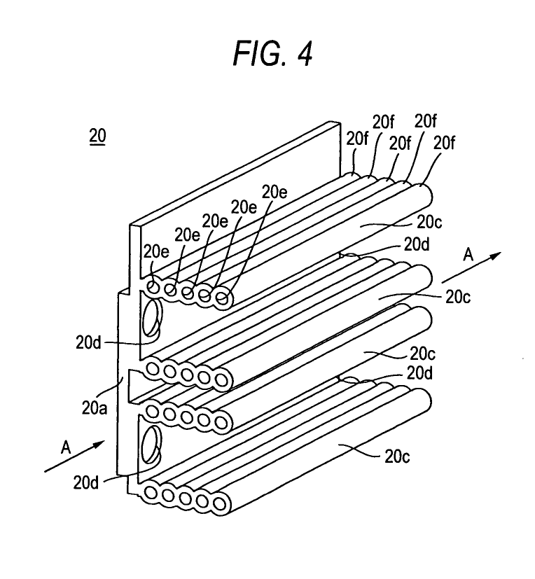

FIG. 1 is a perspective view illustrating an overall configuration of a projector in accordance with an embodiment of the invention. FIG. 2 is a top view of the projector in accordance with the embodiment shown in FIG. 1. FIG. 3 is a cross-sectional view for explaining a structure for attaching a DMD device and a heat radiating plate used in the projector in accordance with the embodiment shown in FIG. 1. FIG. 4 is a perspective view of the heat radiating plate used in the projector in accordance with the embodiment shown in FIG. 1. First, referring to FIGS. 1 to 4, a description will be given of the structure of the projector in accordance with the embodiment of the invention.

As shown in FIG. 1, a projector in accordance with an embodiment of the invention has a lower case 1, a front case 2, and a rear case 3. A ventilation port 1a for introducing air is provided in a side surface of the lower case 1. The front case 2 is attached to the lower case 1, and the rear case 3 is attached to the lower case 1. Further, a ventilation port 3a for introducing air is provided in the rear case 3.

In addition, a lamp case holder 4 made of a heat-resistant resin is installed in the lower case 1 in the vicinity of the front case 2. As shown in FIG. 2, a lamp case 6 with a light source lamp 5 fitted therein is accommodated inside this lamp case holder 4. This lamp case 6 is formed of a heat-resistant resin material with glass fibers added thereto. Further, the light source lamp 5 has a glass-made light source 5a for emitting light and a glass-made reflector 5b for reflecting and focusing the light emitted from the light source 5a. In addition, as for the light source lamp 5, its temperature at which it functions most effectively is set to a temperature of about 400° C. to about 500° C. Namely, at a temperature higher than about 500° C., the light source lamp 5 breaks, whereas at a temperature lower than about 400° C., the luminance of the light emitted from the light source 5a of the light source lamp 5 declines. Therefore, it is preferable to set the temperature of the light source lamp 5 to a temperature of about 400° C. to about 500° C.

In addition, as shown in FIGS. 1 and 2, a temperature controlling fan 7 for controlling the temperature of the light source lamp 5 to about 400° C. to about 500° C. by sending air to the light source lamp 5 is provided laterally of the lamp case 6 with the light source lamp 5 fitted therein and the lamp case holder 4. This temperature controlling fan 7 is arranged to send air of a predetermined air volume necessary for maintaining the temperature of the light source lamp 5 to about 400° C. to about 500° C., by controlling the number of revolutions in response to the temperature detected by a temperature sensor (not shown) installed in the vicinity of the light source lamp 5. It should be noted that the temperature controlling fan 7 is an example of the “fans” in accordance with the invention.

In addition, a magnesium-made casting 8 having a lens fitting portion 8a is installed in the lower case 1. A projection lens 9 for projecting an image is fitted in the lens fitting portion 8a of the casting 8. In addition, as shown in FIG. 2, a glass-made light tunnel 10 for shaping the light into a rectangular form is attached to the casting 8 at a position where the light radiated from the light source 5a of the light source lamp 5 is focused. This light tunnel 10 is fixed to the casting 8 by means of a light tunnel clip 11 made of stainless steel. In addition, the light tunnel 10 has an entrance portion 10a into which the light from the light source lamp 5 is incident and an exit portion 10b from which the incident light is emergent, and the light tunnel 10 is formed in a tubular tetrahedral shape. Further, a transmitting member 12, through which the light shaped by the light tunnel 10 is transmitted, is attached to the casting 8 on the exit portion 10b side of the light tunnel 10. It should be noted that the light tunnel 10 and the transmitting member 12 are examples of the “optical parts” in accordance with the invention. In addition, a cooling fan 13 is installed laterally of the light tunnel 10 and the transmitting member 12 in such a manner as to be adjacent to the temperature controlling fan 7. This cooling fan 13 is provided to cool the optical parts such as the light tunnel 10 and the transmitting member 12 by sending air to the optical parts such as the light tunnel 10 and the transmitting member 12. It should be noted that the cooling fan 13 is an example of the “fans” in accordance with the invention.

In addition, a mirror 14 for reflecting the light transmitted through the transmitting member 12 is installed on the casting 8. Further, a DMD device 15 for further reflecting the light reflected by the mirror 14 and supplying the light to the projection lens 9 is provided at a position opposing the lens fitting portion 8a of the casting 8. This DMD device 15 has a heat-resisting temperature of about 60° C. to about 65° C. It should be noted that the DMD device 15 is an example of the “devices” in accordance with the invention. A lens 16 for focusing the light reflected by the mirror 14 onto the DMD device 15 is provided between the DMD device 15 and the mirror 14. Further, as shown in FIG. 3, a reflecting portion 15a for reflecting the light and an attaching portion 15b located on the reverse surface side of the reflecting portion 15a are formed on the DMD device 15. A heat radiating sheet 17 formed of a silicone sheet or the like is attached to the attaching portion 15b of the DMD device 15. In addition, the DMD device 15 is mounted on a printed board 19 by means of a resin-made socket 18. A through hole 19a is provided in the printed board 19 at that position on the printed board 19 that corresponds to the heat radiating sheet 17.

In addition, an aluminum-made heat radiating plate 20 for radiating the heat of the DMD device 15 is provided so as to abut against the heat radiating sheet 17 of the DMD device 15 through the through hole 19a in the printed board 19. As shown in FIG. 2, this heat radiating plate 20 is installed in a path of influx (arrow A in FIG. 2) of air from the ventilation port 1a of the lower case 1 to the temperature controlling fan 7 and the cooling fan 13. In addition, the heat radiating plate 20 has a base portion 20a, an abutment portion 20b, and a radiating fin portion 20c, as shown in FIG. 3.

In addition, as shown in FIGS. 3 and 4, four threaded holes 20d are provided in the base portion 20a of the heat radiating plate 20. A screw 22 loaded with a compression coil spring 21 is inserted in each of the four threaded holes 20d. The heat radiating plate 20 is attached to the casting 8 through the printed board 19 by means of these screws 22. It should be noted that the compression coil spring 21 loaded on the screw 22 is provided to abut the heat radiating plate 20 against the heat radiating sheet 17 attached to the DMD device 15 with a fixed pressing force. In addition, the abutment portion 20b of the heat radiating plate 20 is integrally formed on the base portion 20a in such a manner as to project from the reverse surface of the base portion 20a. This abutment portion 20b is abutted against the heat radiating sheet 17 of the DMD device 15 through the through hole 19a in the printed board 19. In consequence, the heat of the DMD device 15 is transmitted to the abutment portion 20b of the heat radiating plate 20 through the heat radiating sheet 17.

Here, in this embodiment, the four heat radiating fin portions 20c are provided integrally on the surface of the base portion 20a of the heat radiating plate 20 by being spaced apart at predetermined intervals. In addition, the heat radiating fin portions 20c are formed in such a manner as to extend in a substantially perpendicular direction to the surface of the base portion 20a. Further, the heat radiating fin portions 20c have thicknesses of about 5 mm and widths of about 20 mm to about 25 mm. Five circular through holes 20e having diameters of about 1.2 mm, through which air can pass are formed in each of the four heat radiating fin portions 20c. These five through holes 20e are formed in such a manner as to extend in a direction along the path of influx (arrow A in FIGS. 2 and 4) of air to the temperature controlling fan 7 and the cooling fan 13. Further, the five through holes 20e are formed at predetermined intervals along a substantially perpendicular direction to the surface of the base portion 20a. In addition, outer surfaces of the heat radiating fin portion 20c are formed in a shape in which five convex portions 20f having convex shapes reflecting the circular shapes of the through holes 20e are connected.

Next, referring to FIGS. 2 and 4, a description will be given of the operation of the projector in accordance with this embodiment. First, as shown in FIG. 2, the light emitted from the light source 5a of the light source lamp 5 is focused by the reflector 5b of the light source lamp 5, and is thereby made incident into the entrance portion 10a of the light tunnel 10. Then, the light incident into the entrance potion 110a of the light tunnel 10 is shaped into a rectangular form and is made emergent from the exit potion 10b of the light tunnel 10. The light emergent from the exit potion 10b of the light tunnel 10 advances in the direction of arrow B in FIG. 2, is transmitted through the transmitting member 12, and is made incident upon the mirror 14. The light incident upon the mirror 14 is reflected by the mirror 14 in the direction of arrow C in FIG. 2. The light reflected by this mirror 14 is made incident upon the DMD device 15 through the lens 16. The light incident upon the DMD device 15 is reflected by the DMD device 15 in the direction of arrow D in FIG. 2, and is supplied to the projection lens 9. Consequently, the image is projected from the projection lens 9 onto a screen or the like.

During the operation of the above-described projector, the temperature controlling fan 7 and the cooling fan 13 are rotated. First, as the temperature controlling fan 7 is rotated, a predetermined volume of air is sent to the light source lamp 5. The volume of air sent to the light source lamp 5 is adjusted by controlling the number of revolutions of the temperature controlling fan 7 on the basis of the temperature detected by a temperature sensor (not shown) installed in the vicinity of the light source lamp 5. As a result, the temperature of the light source lamp 5 is maintained in the temperature range of about 400° C. to about 500° C. Further, as the cooling fan 13 is rotated, a predetermined volume of air is sent to the optical parts such as the light tunnel 10 and the transmitting member 12. Consequently, the optical parts such as the light tunnel 10 and the transmitting member 12 are cooled. In addition, as the temperature controlling fan 7 and the cooling fan 13 rotate, air flows to the temperature controlling fan 7 and the cooling fan 13 from the ventilation port 1a of the lower case 1 and the ventilation port 3a of the rear case 3, as shown in FIG. 2. The air which flowed in from the ventilation port 1a of the lower case 1 passes the vicinity of the heat radiating plate 20 for radiating the heat of the DMD device 15, and flows in to the temperature controlling fan 7 and the cooling fan 13.

At this juncture, in this embodiment, air passes through the through holes 20e formed in the heat radiating fin portions 20c of the heat radiating plate 20 in such a manner as to extend in the direction along the path of influx (arrow A in FIG. 4) of air. Consequently, as the heat from the DMD device 15 (see FIG. 2) is radiated from surfaces of the through holes 20e, the air whose temperature has risen is checked from stagnating in the through holes 20e. In addition, since the air passes through the through holes 20e, the interruption of the flow of air by the heat radiating fin portions 20c of the heat radiating plate 20 is checked.

In this embodiment, as described above, the heat radiating fin portions 20c are provided on the heat radiating plate 20 for radiating the heat of the DMD device 15, and the five through holes 20e are provided in each of these heat radiating fin portions 20c by being spaced apart at predetermined intervals along a substantially perpendicular direction to the surface of the base portion 20a of the heat radiating plate 20. Therefore, it is possible to substantially increase the surface areas of the heat radiating fin portions 20c by the portion of the surface areas of the through holes 20e. Consequently, it is possible to improve the heat dissipation effect of the heat radiating plate 20 without substantially increasing the number and size of the heat radiating fin portions 20c, so that it is possible to effectively control the rise in the temperature of the DMD device 15.

In addition, in this embodiment, the through holes 20e of the heat radiating fin portions 20c are provided in such a manner as to extend in the direction along the path of influx of air to the temperature controlling fan 7 and the cooling fan 13, thereby allowing the air to pass through the through holes 20e of the heat radiating fin portions 20c. Therefore, as the heat from the DMD device 15 is radiated from the surfaces of the through holes 20e, the air whose temperature has risen can be checked from stagnating in the through holes 20e. Consequently, it is possible to further improve the heat dissipation effect of the heat radiating plate 20.

In addition, in this embodiment, as the through holes 20e of the heat radiating fin portions 20c are provided in such a manner as to extend in the direction along the path of influx of air to the temperature controlling fan 7 and the cooling fan 13, the air directed toward the temperature controlling fan 7 and the cooling fan 13 passes through the through holes 20e. Therefore, even if the heat radiating plate 20 including the heat radiating fin portions 20c is provided in the path of influx of air to the temperature controlling fan 7 and the cooling fan 13, it is possible to check the interruption of the flow of air directed toward the temperature controlling fan 7 and the cooling fan 13 by the heat radiating plate 20. Consequently, since it is possible to check the interruption of the influx of air to the temperature controlling fan 7 and the cooling fan 13, a predetermined volume of air can be sent to the light source lamp 5 and the optical parts such as the light tunnel 10 and the transmitting member 12 by the temperature controlling fan 7 and the cooling fan 13, respectively. For this reason, it is possible to more reliably maintain the temperature of the light source lamp 5 in the temperature range of about 400° C. to about 500° C., and more effectively cool optical parts such as the light tunnel 10 and the transmitting member 12 by the cooling fan 13. Thus, since the temperature of the light source lamp 5 can be more reliably maintained at the temperature of 400° C. to about 500° C., it is possible to prevent the breakage of the light source lamp 5 caused by the fact that the temperature of the light source lamp 5 rises above about 500° C., and suppress a decline in the luminance of the light emitted from the light source 5a of the light source lamp 5 owing to the fact that the temperature of the light source lamp 5 falls below 400° C.

In addition, in this embodiment, as the outer surfaces of the heat radiating fin portion 20c are formed in the shape in which the five convex portions 20f having convex shapes reflecting the circular shapes of the through holes 20e are connected, the surface area of the heat radiating fin portion 20c can be increased further as compared with the case where the outer surfaces of the heat radiating fin portion 20c of the heat radiating plate 20 are formed in the shape of flat surfaces. As a result, since the heat dissipation effect can be improved further, it is possible to more effectively control the rise in the temperature of the DMD device 15 as compared with the case where the outer surfaces of the heat radiating fin portion 20c of the heat radiating plate 20 are formed in the shape of flat surfaces.

In addition, in this embodiment, as the heat radiating fin portions 20c including the through holes 20e are integrally formed on the base portion 20a of the heat radiating plate 20, the number of parts does not increase even if the heat radiating fin portions 20 including the through holes 20e are provided. As a result, it is possible to improve the heat dissipation effect of the heat radiating plate 20 by the through holes 20e without increasing the number of parts.

It should be appreciated that the embodiment disclosed herein is described by way of illustration, not by way of limitation in all aspects. The scope of the invention is defined not by the embodiment above but by the claims, and is intended to cover all modifications and variations within the equivalent meaning and scope of the claims.

For example, although in the above-described embodiment the through holes 20e in the heat radiating fin portions 20c of the heat radiating plate 20 are formed in such a manner as to extend in the direction along the path of influx of air to the temperature controlling fan 7 and the cooling fan 13, the invention is not limited to the same, and the through holes in the heat radiating fin portions of the heat radiating plate may be formed in such a manner as to extend in a direction other than the direction along the path of influx of air to the temperature controlling fan and the cooling fan.

In addition, although in the above-described embodiment the outer surfaces of the heat radiating fin portion 20c of the heat radiating plate 20 are formed in the shape in which the five convex portions 20f having convex shapes reflecting the circular shapes of the through holes 20e are connected, the invention is not limited to the same, and the outer surfaces of the heat radiating fin portion of the heat radiating plate may be formed in a shape other than such a shape. For example, the outer surfaces of the heat radiating fin portion of the heat radiating plate may be formed in a shape in which convex portions having corners are connected or in a flat shape or the like.

In addition, although in the above-described embodiment the through holes 20e of the heat radiating fin portion 20c of the heat radiating plate 20 are formed in the circular shape, the invention is not limited to the same, and the through holes may be formed in another shape. For example, the through holes may be formed in a quadrangular or triangular shape.

In addition, although in the above-described embodiment two fans including the temperature controlling fan 7 and the cooling fan 13 are provided, the invention is not limited to the same, and only one fan may be provided to send air to the light source lamp and the optical parts such as the light tunnel and the transmitting member. Furthermore, three or more fans may be provided.

In addition, although in the above-described embodiment the heat radiating fin portions 20c having the through holes 20e are provided integrally on the heat radiating plate 20, the invention is not limited to the same, and the heat radiating fin portions having the through holes may be provided separately from the heat radiating plate.

1. A projector comprising:
a light source lamp;
a projection lens which projects an image;
a DMD device which reflects light emitted from the light source lamp and supplies the light to the projection lens;
a temperature controlling fan which controls a temperature of the light-source lamp by sending air to the light source lamp;
an optical part;
a cooling fan which cools the optical part by sending air to the optical part; and
a heat radiating plate which radiates a heat of the DVD device,
wherein the heat radiation plate is provided in a path of influx of air to the temperature controlling fan and the cooling fan and in close proximity to the DMD device, and includes a base portion and a plurality of heat radiating fin portions, the base portion having a portion located in close proximity to the DMD device, and the plurality of heat radiating fin portions being provided integrally on a surface of the base portion, being spaced apart at predetermined intervals and extending in a substantially perpendicular direction to the surface of the base portion,
wherein each of the plurality of heat radiating fin portions has a plurality of through holes through which air can pass and which extend in a direction along the path of influx of air to the temperature controlling fan and the cooling fan, the plurality of through holes being spaced apart at predetermined intervals along the substantially perpendicular direction to the surface of the base portion, and
wherein an outer surface of the heat radiating fin portion is formed in a shape in which a plurality of convex-portions having a convex shape reflecting a shape of the plurality of through holes are connected.

2. A projector comprising:
a light source lamp;
a projection lens;
a device which reflects light emitted from the light source lamp and supplies the light to the projection lens; and
a heat radiating plate which radiates a heat of the device,
wherein the heat radiating plate includes a heat radiating fin portion which has a through hole through which air can pass.

3. The projector according to claim 2, further comprising:
an optical part;
a fan which sends air to the optical part and the light source lamp,
wherein the through hole extends in a direction along a path of influx of air to the fan.

4. The projector according to claim 2,
wherein an outer surface of the heat radiating fin portion is formed in a shape in which a plurality of convex portions having a convex shape reflecting a shape of the through hole are connected.

5. The projector according to claim 3,
wherein an outer surface of the heat radiating fin portion is formed in a shape in which a plurality of convex portions having a convex shape reflecting a shape of the through hole are connected.

6. The projector according to claim 2,
wherein the heat radiating fin portion including the through hole is provided integrally on the heat radiating plate.

7. The projector according to claim 3,
wherein the heat radiating fin portion including the through hole is provided integrally on the heat radiating plate.

8. The projector according to claim 4,
wherein the heat radiating fin portion including the throughhole is provided integrally on the heat radiating plate.

9. The projector according to claim 5,
wherein the heat radiating fin portion including the through hole is provided integrally on the heat radiating plate.
